(19) United States
(12) Patent Application Publication
(10) Pub. No.: US 2025/0354944 A1
(43) Pub. Date: Nov. 20, 2025

(54) EDGE POSITION DETERMINATION METHOD, EDGE POSITION DETERMINATION APPARATUS, AND EDGE ANALYSIS METHOD

(71) Applicant: Gigaphoton Inc., Tochigi (JP)

(72) Inventors: Koichi FUJII, Oyama-shi (JP); Takamitsu KOMAKI, Oyama-shi (JP)

(73) Assignee: Gigaphoton Inc., Tochigi (JP)

(21) Appl. No.: 19/169,578

(22) Filed: Apr. 3, 2025

(30) Foreign Application Priority Data
May 15, 2024 (JP) 2024-079730

(51) Int. Cl. G01N 23/2251; G01B 15/00

(52) U.S. Cl. CPC G01N 23/2251; G01B 15/00; G01N 2223/401; G01N 2223/6116

(57) ABSTRACT

An edge position determination method includes determining an average edge position by aggregating intensity values in an extension direction of lines in a SEM image of line-and-space, fitting a first intensity profile indicating distribution of the intensity values in a direction perpendicular to the extension direction at coordinates indicating each position in the extension direction in the SEM image using a weight function in which a weight at the average edge position is the largest and a fitting function defined in accordance with the first intensity profile, and determining an edge position at the coordinates from a second intensity profile obtained through the fitting.

### CROSS-REFERENCE TO RELATED APPLICATIONS

The present application claims the benefit of Japanese Patent Application No. 2024-079730, filed on May 15, 2024, the entire contents of which are hereby incorporated by reference.

### BACKGROUND

### 1. Technical Field

The present disclosure relates to an edge position determination method, an edge position determination apparatus, and an edge analysis method.

### 2. Related Art

In recent years, an improvement in resolution of semiconductor exposure apparatuses has been desired with miniaturization and high integration of semiconductor integrated circuits. For this purpose, exposure light sources that output light having shorter wavelengths have been developed. For example, KrF excimer laser apparatuses that output laser beams having wavelengths of about 248 nm and ArF excimer laser apparatuses that output laser beams having wavelengths of about 193 nm are used as exposure gas laser apparatuses.

Spectral linewidths of spontaneous oscillation light of the KrF excimer laser apparatuses and the ArF excimer laser apparatuses are as wide as 350 μm to 400 μm. For this reason, if a projection lens is configured of a material that transmits ultraviolet light such as KrF and ArF laser beams, chromatic aberration may occur. As a result, resolution may be degraded. Thus, a spectral linewidth of a laser beam output from a gas laser apparatus needs to be narrowed to the extent that the chromatic aberration can be ignored. Therefore, a line narrowing module (LNM) including a line narrowing element (such as etalon or grating) may be included in a laser resonator of the gas laser apparatus in order to narrow the spectral linewidth. A gas laser apparatus with a narrowed spectral linewidth is referred to as a line narrowed gas laser apparatus.

### LIST OF DOCUMENTS

### Patent Documents

Patent Document 1: Japanese Unexamined Patent Application Publication No. 2016-217816

### SUMMARY

An edge position determination method according to an aspect of the present disclosure may include determining an average edge position by aggregating intensity values in an extension direction of lines in a SEM image of line-and-space, fitting a first intensity profile indicating distribution of the intensity values in a direction perpendicular to the extension direction at coordinates indicating each position in the extension direction in the SEM image using a weight function in which a weight at the average edge position is the largest and a fitting function defined in accordance with the first intensity profile, and determining an edge position at the coordinates from a second intensity profile obtained through the fitting.

An edge position determination apparatus according to an aspect of the present disclosure may include a communication controller and a processor. The communication controller may acquire a SEM image of line-and-space. The processor may determine an average edge position by aggregating intensity values in an extension direction of lines in the SEM image, fit a first intensity profile in a direction perpendicular to the extension direction at coordinates indicating each position in the extension direction in the SEM image using a weight function in which a weight at the average edge position is the largest and a fitting function defined in accordance with the first intensity profile, and determine an edge position at the coordinates from a second intensity profile obtained through the fitting.

An edge analysis method according to an aspect of the present disclosure includes determining an average edge position by aggregating intensity values in an extension direction of lines in a SEM image of line-and-space, fitting a first intensity profile in a direction perpendicular to the extension direction at coordinates indicating each position in the extension direction in the SEM image using a weight function in which a weight at the average edge position is the largest and a fitting function defined in accordance with the first intensity profile, determining an edge position at the coordinates from a second intensity profile obtained through the fitting, and performing PSD analysis on the edge position at each of a plurality of positions in the extension direction.

Some embodiments of the present disclosure will be described below merely as examples with reference to the accompanying drawings.

### BRIEF DESCRIPTION OF THE DRAWINGS

FIG. 1 illustrates a configuration of an edge position determination apparatus in a comparative example.

FIG. 2 illustrates a part of a SEM image including a line-and-space pattern.

FIG. 3 is a flowchart illustrating an overview of edge analysis processing in the comparative example.

FIG. 4 illustrates an example of a SEM image of line-and-space.

FIG. 5 illustrates an example of an intensity profile in an X direction at a coordinate i in a Y direction in FIG. 4.

FIG. 6 is a flowchart illustrating details of processing of determining pattern edges from a SEM image in a first embodiment.

FIG. 7 is a flowchart illustrating details of processing of determining an average edge position.

FIG. 8 illustrates an example of an average intensity profile.

FIG. 9 illustrates an example of a weight function.

FIG. 10 illustrates another example of the weight function.

FIG. 11 illustrates another example of the weight function.

FIG. 12 illustrates a state where the weight function has been added by the number of average edge positions.

FIG. 13 illustrates an example of an individual profile.

FIG. 14 illustrates an example of a weighted individual profile.

FIG. 15 is a flowchart illustrating details of processing of determining edge positions.

FIG. 16 illustrates an example of a smoothed individual profile.

FIG. 17 illustrates a state where edge positions included in alignment data are aligned in an XY plane.

FIG. 18 illustrates an example of a result of PSD analysis on the pattern edges.

FIG. 19 is a flowchart illustrating details of processing of determining pattern edges from a SEM image in a second embodiment.

### DESCRIPTION OF EMBODIMENTS

### <Contents>

1. Comparative Example
2. Problems of Comparative Example
3. Method of Selectively Reducing Noise by Multiplying Weight Function f(x)
   3.1 Processing of Determining Pattern Edges from SEM Image
   3.2 Effects
4. Method Using Weight Function f(x) as Weight of Local Regression
   4.1 Processing of Determining Pattern Edges from SEM Image
   4.2 Effects
5. Others

Hereinafter, embodiments of the present disclosure will be described in detail with reference to the drawings. The embodiments described below illustrate some examples of the present disclosure and do not limit the contents of the present disclosure. Also, all configurations and operations described in the embodiments are not necessarily essential as the configurations and operations of the present disclosure. Note that the same components will be denoted by the same reference signs and repeated description thereof will be omitted.

### 1. Comparative Example

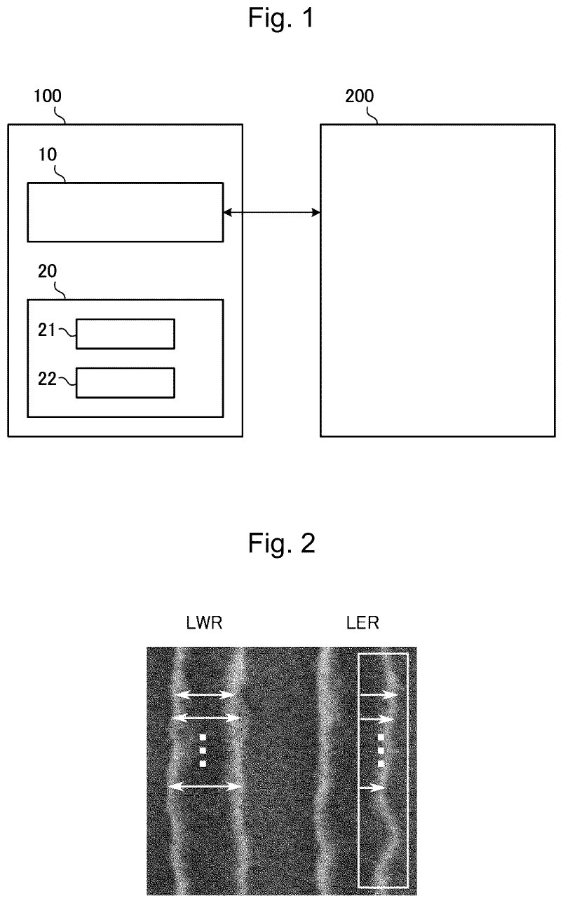

FIG. 1 illustrates a configuration of an edge position determination apparatus 100 in a comparative example. The comparative example of the present disclosure is a form recognized by the applicant as known only by the applicant and is not a publicly known example admitted by the applicant.

The edge position determination apparatus 100 includes a communication controller 10 and a processor 20. The communication controller 10 is connected to external devices such as a critical dimension scanning electron microscope (CD-SEM) 200 and controls communication with the external devices. The communication controller 10 acquires a SEM image of a semiconductor substrate, which is not illustrated, captured by the CD-SEM 200 from the CD-SEM 200 or another external device holding the SEM image. The SEM image includes a thin-line-shaped worked pattern called a line-and-space pattern and formed through exposure and development of the semiconductor substrate.

The processor 20 is a processing device including a memory 21 that stores a control program and a central processing unit (CPU) 22 that executes the control program. The processor 20 is specifically configured or programmed to perform various kinds of processing included in the present disclosure. The processor 20 uses the SEM image acquired by the communication controller 10 to determine edge positions of the line-and-space pattern. Furthermore, the processor 20 evaluates exposure performance by performing edge analysis using the edge positions.

FIG. 2 illustrates a part of an SEM image including a line-and-space pattern. In the SEM image, edges that are boundaries between lines and spaces appear bright, and line parts and space parts other than the edges appear dark. Line edge roughness (LER) indicates deviation of the edges from ideal positions, and line width roughness (LWR) indicates a variation in distance between edges on both sides of a line. Demands for LER and LWR in semiconductor lithography have become increasingly stringent year by year. In order to accurately analyze causal factors of LER and LWR, it is necessary to accurately determine the edge positions. In the following explanation, LER and LWR will not be distinguished from each other and will be referred to only as LER as a representative.

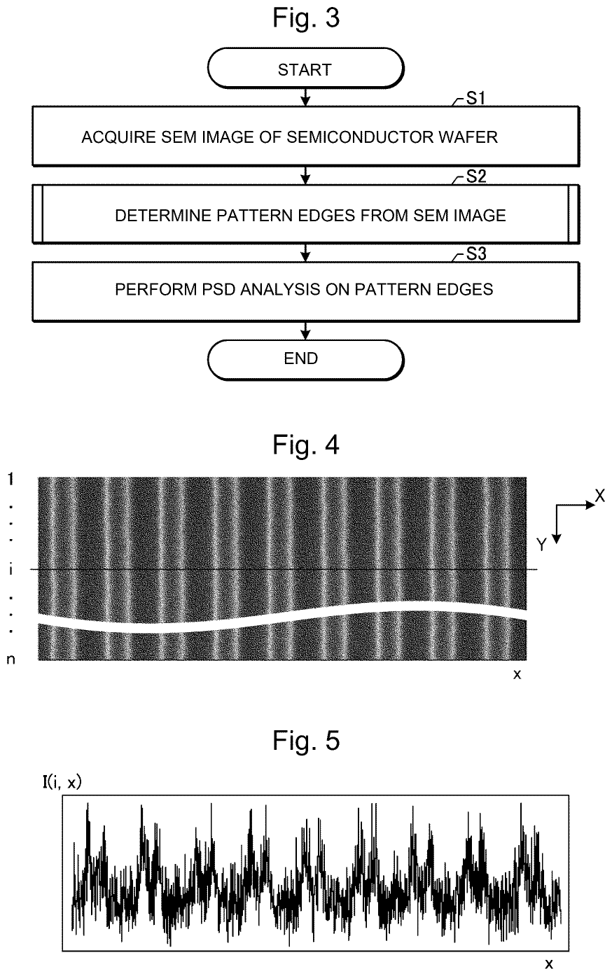

FIG. 3 is a flowchart illustrating an overview of edge analysis processing in the comparative example. The edge analysis is performed as follows.

In S1, the processor 20 acquires a SEM image of an exposed and developed semiconductor wafer from the communication controller 10. In S2, the processor 20 determines pattern edges from the SEM image. The pattern edges are given as alignment data of multiple edge positions obtained from the SEM image. In S3, the processor 20 performs power spectral density (PSD) analysis on the pattern edges. The PSD analysis is a signal analysis performed by decomposing a signal into a signal intensity per unit frequency. The PSD analysis of the pattern edges means that the PSD analysis is performed with LER regarded as a signal and is for examining what kind of spatial frequency components the LER is configured of.

FIG. 4 illustrates an example of the SEM image of line-and-space. An extension direction of the lines is defined as a Y direction. A direction perpendicular to the extension direction is defined as an X direction. A position in the x-direction is indicated by x. When the number of pixels in the SEM image in the Y direction is defined as n, and a coordinate at an arbitrary position in the Y direction is defined as i, i may be an integer value from 1 to n.

### 2. Problems of Comparative Example

FIG. 5 illustrates an example of an intensity profile in the X direction at the coordinate i in the Y direction in FIG. 4. The intensity profile illustrated in FIG. 5 is defined as an individual profile I(i, x). The individual profile I(i, x) corresponds to the first intensity profile in the present disclosure. Since the edges appear bright in FIG. 4, it is conceivable that parts having high intensities in FIG. 5 are regarded as edges to determine edge positions. However, since the SEM image is an image with a large amount of noise, there are two problems described below.
Problem 1: A plurality of pixels having high intensities are present near the edge positions, and it may be difficult to determine which pixels correspond to the edge positions.
Problem 2: In a case where it is attempted to determine the edge positions using a constant intensity value as a threshold value, parts that are not true edge positions may be detected as the edge positions, or true edge positions may not be able to be detected.

As a first method of solving the problems, a method of smoothing noise using a Gaussian filter or the like and then detecting the edge positions is conceivable. However, information regarding high spatial frequency components may be lost due to the smoothing of the noise.

As a second method of solving the problems, it is conceivable that after obtaining an integrated luminance profile in the extension direction of the pattern and obtaining a functional form of the fitting function, the fitting is performed using an individual luminance profile that has not been integrated and the fitting function having the obtained functional form as described in Japanese Patent Application Publication No. 2016-217816. However, if a large amount of noise is included in the individual luminance profile, the edge positions may not be accurately detected. Furthermore, since the functional form of the fitting function is obtained from the integrated luminance profile, the fitting may be performed under influences of luminance profiles at other positions in the extension direction of the pattern.

Embodiments described below relate to suppressing the influences of noise on SEM images of line-and-space and accurately detecting edge positions.

### 3. Method of Selectively Reducing Noise by Multiplying Weight Function f(x)

3.1 Processing of Determining Pattern Edges from SEM Image

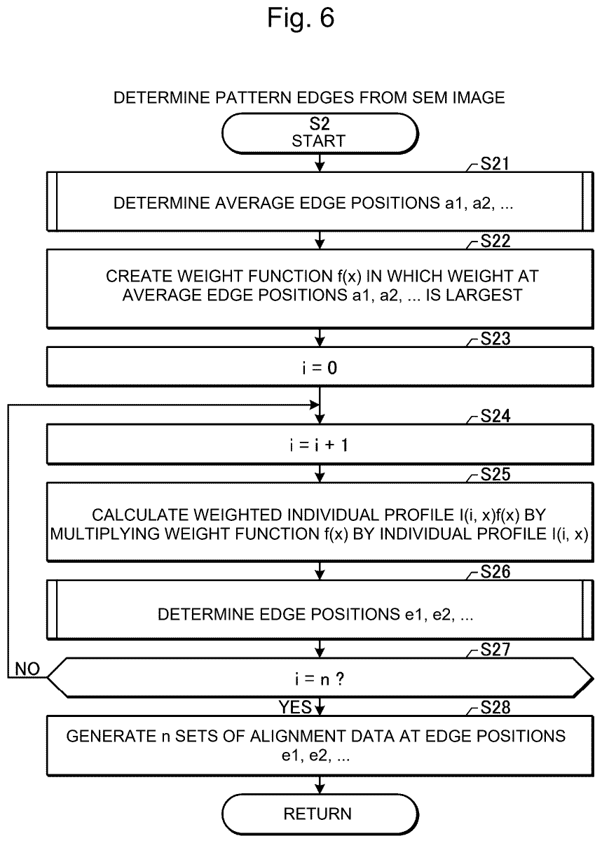

FIG. 6 is a flowchart illustrating details of processing of determining pattern edges from a SEM image according to the first embodiment. The configuration of the edge position determination apparatus 100 according to the first embodiment is similar to that described with reference to FIG. 1. Edge analysis processing in the first embodiment is similar to that described with reference to FIG. 3. FIG. 6 corresponds to a sub-routine of S2 in FIG. 3.

In S21, the processor 20 determines one or more average edge positions a1, a2, . . . , from a SEM image. Assuming that there are edges on both sides of a single line, the number of average edge positions a1, a2, . . . included in a single SEM image is twice the number of lines.

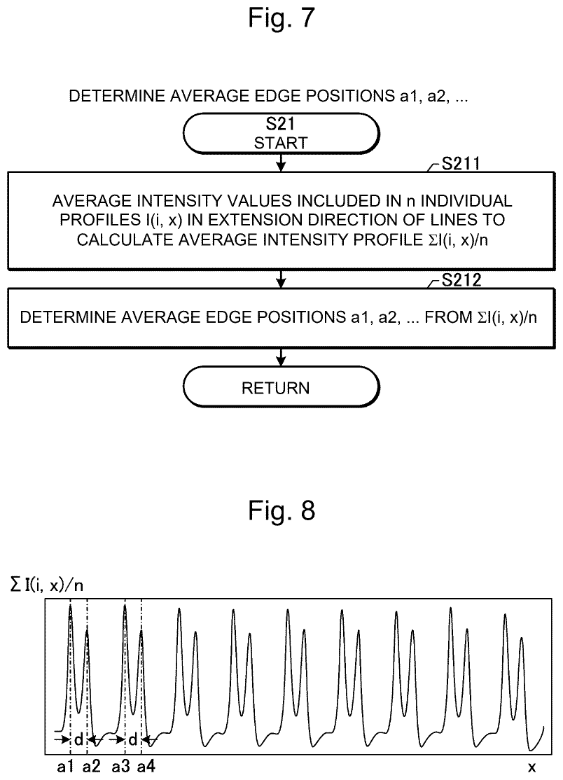

FIG. 7 is a flowchart illustrating details of processing of determining the average edge positions a1, a2, . . . . FIG. 7 corresponds to a sub-routine of S21 in FIG. 6.

In S211, the processor 20 averages intensity values included in n individual profiles I(i, x) in the Y direction to calculate an average intensity profile ΣI(i, x)/n. The average intensity profile ΣI(i, x)/n corresponds to the fourth intensity profile in the present disclosure. The average intensity profile ΣI(i, x)/n is obtained by aggregating the individual profiles I(i, x) from i=1 to i=n for each value of x and dividing the result by n.

FIG. 8 illustrates an example of the average intensity profile ΣI(i, x)/n. While the individual profile I(i, x) illustrated in FIG. 5 has large noise, the average intensity profile ΣI(i, x)/n illustrated in FIG. 8 is averaged in the Y direction and has reduced noise.

Referring back to FIG. 7, the processor 20 determines the average edge positions a1, a2, . . . , from the average intensity profile ΣI(i, x)/n in S212. For example, peak positions may be detected from the average intensity profile ΣI(i, x)/n and may be regarded as the average edge positions a1, a2, . . . , or the center positions of ranges of the average intensity profile ΣI(i, x)/n that are equal to or greater than a threshold value may be regarded as the average edge positions a1, a2, . . . . Also, the average intensity profile ΣI(i, x)/n may be smoothed by either the locally weighted scatterplot smoothing (LOWESS) method or the locally estimated scatterplot smoothing (LOESS) method to thereby determine the average edge positions a1, a2, . . . . The interval between one average edge position and another closest average edge position is defined as d.

After S212 in FIG. 7, the processor 20 ends the processing of the flowchart and returns to the processing illustrated in FIG. 6.

In S22 in FIG. 6, the processor 20 creates a weight function f(x) in which the weight at the average edge positions a1, a2, . . . is the largest.

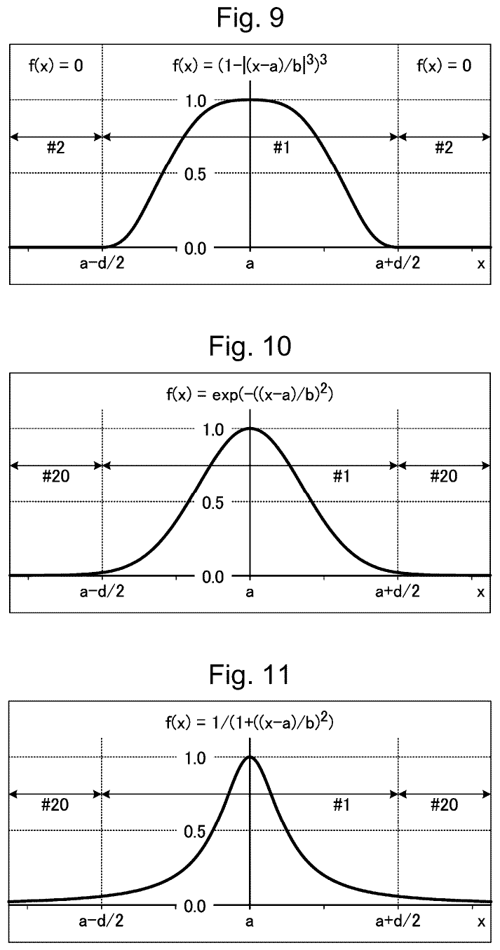

FIGS. 9 to 11 each illustrate another example of the weight function f(x). In each of FIGS. 9 to 11, the average edge position is defined as a, a constant in accordance with the magnification of the weight function f(x) in the X direction is defined as b, and a section where the distance from the average edge position a is equal to or less than a predetermined value is defined as a first section #1. The predetermined value is a value smaller than the distance d and is, for example, d/2. In each of FIGS. 9 to 11, the value of the weight function f(x) at the average edge position a has a peak value of 1.0, and the weight function f(x) is symmetrical with respect to the average edge position a in the first section #1.

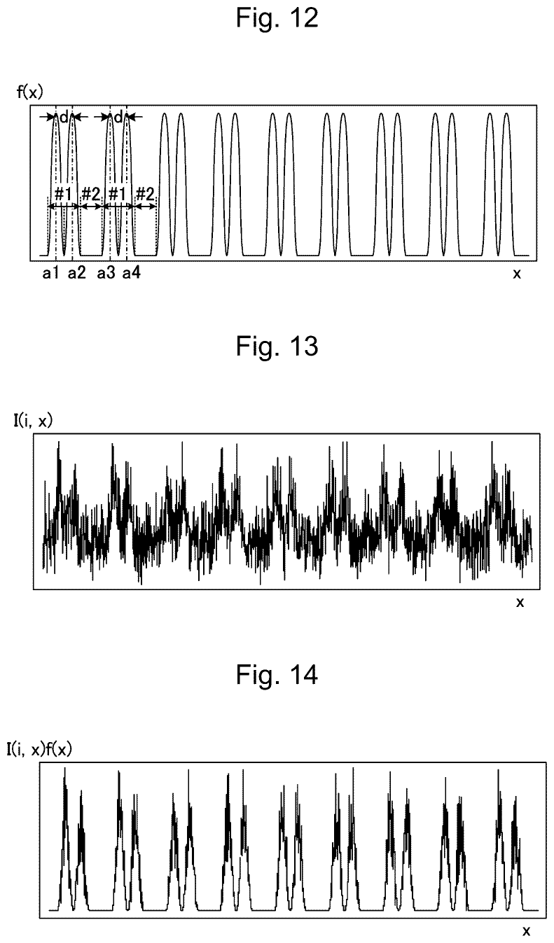

A section where the distance from the average edge position a in FIG. 9 is greater than the predetermined value is defined as a second section #2, and a section where the distance from the average edge position a is greater than the predetermined value in FIGS. 10 and 11 is defined as a second section #20. In the second sections #2 and #20, the values of the weight function f(x) are equal to or less than half the peak value. Furthermore, in each of FIGS. 9 to 11, the values of the weight function f(x) at the positions a+d/2 and a−d/2 where the distance from the average edge position a is half the interval d are equal to or less than half the peak value.

FIG. 9 illustrates a case where the weight function f(x) is (1−|(x−a)/b|³)³ in a section where |(x−a)/b| is equal to or less than 1 and the weight function f(x) is 0 in a section where |(x−a)/b| is greater than 1. Specifically, FIG. 9 illustrates a case where b is d/2. When the section where |(x−a)/b| is equal to or less than 1 includes the entire first section #1, or when the section where |(x−a)/b| is equal to or less than 1 coincides with the first section #1, the weight function f(x) illustrated in FIG. 9 is a function that decreases as the distance from the average edge position a increases in the first section #1 when the increase and the decrease are captured with reference to the average edge position a. In the first section, the absolute value of the derivative of this weight function f(x) is the smallest at the average edge position a and is, for example, zero.

In FIG. 9, when the section where |(x−a)/b| is greater than 1 includes the entire second section #2, or when the section where |(x−a)/b| is greater than 1 coincides with the second section #2, the weight function f(x) is a constant value regardless of the distance from the average edge position a in the second section #2, and the constant value is zero.

FIG. 10 illustrates a case where the weight function f(x) is exp(−((x−a)/b)²). FIG. 11 illustrates a case where the weight function f(x) is 1/(1+((x−a)/b)²). The weight function f(x) illustrated in FIGS. 10 and 11 is a function that decreases as the distance from the average edge position a increases in all the sections including the first section #1 and the second section #20 when the increase and the decrease are captured with reference to the average edge position a. The absolute value of the derivative of the weight function f(x) is the smallest at the average edge position a and is, for example, zero.

FIG. 12 illustrates a state where the weight function f(x) has been added by the number of averaged edge positions a1, a2, . . . . Although the first section #1 of the weight function f(x) centered on the average edge position a1 and the first section #1 of the weight function f(x) centered on the average edge position a2 are connected substantially without any gap, the weight is reduced in the middle of the average edge positions a1 and a2 because the value of the weight function f(x) in a case where the distance from the average edge positions a1 and a2 is half the interval d is equal to or less than half the peak value. The weight is also reduced in the second section #2, which is far from both the average edge positions a2 and a3.

Referring back to FIG. 6, the processor 20 sets the value of the coordinate i in the Y direction to zero in S23. In S24, the processor 20 adds 1 to the value of i to update the value of i.

In S25, the processor 20 calculates the weighted individual profile I(i, x)f(x) by multiplying the weight function f(x) by the individual profile I(i, x). Here, the weight function f(x) used is the same regardless of the position in the Y direction. The weighted individual profile I(i, x) f(x) corresponds to the third intensity profile in the present disclosure.

FIG. 13 illustrates an example of the individual profile I(i, x), which corresponds to redisplaying of FIG. 5. FIG. 14 illustrates an example of the weighted individual profile I(i, x) f(x). While a large weight is given to a part close to the average edge positions a1, a2, . . . , a large weight is not given to a part far from the average edge positions a1, a2, . . . , and noise is reduced.

Referring back to FIG. 6, the processor 20 determines edge positions e1, e2, . . . from the weighted individual profile I(i, x) f(x) in S26.

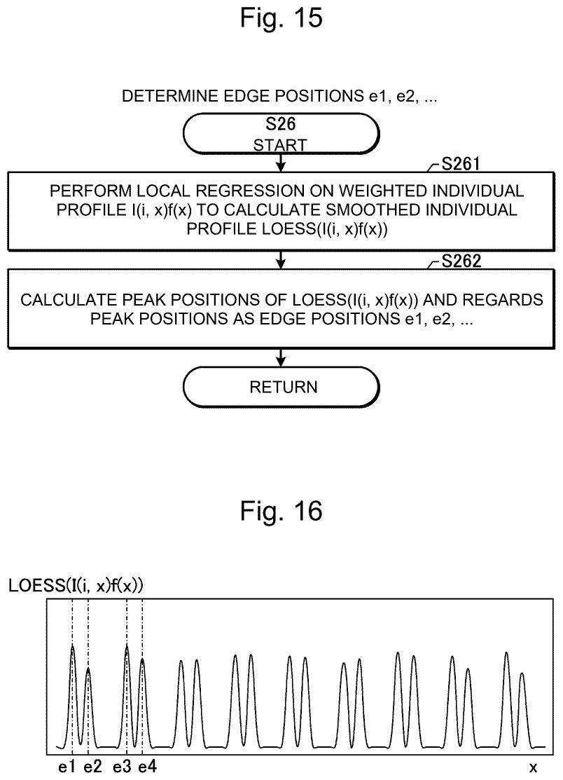

FIG. 15 is a flowchart illustrating details of processing of determining the edge positions e1, e2, . . . . FIG. 15 corresponds to a sub-routine of S26 in FIG. 6.

In S261, the processor 20 performs local regression on the weighted individual profile I(i, x) f(x) to calculate a smoothed individual profile LOESS (I(i, x) f(x)). The smoothed individual profile LOESS (I(i, x) f(x)) is an example of the second intensity profile in the present disclosure. The processing of the local regression includes fitting processing using a fitting function defined in accordance with the weighted individual profile I(i, x) f(x). Either the LOWESS method or the LOESS method can be used as a fitting method.

FIG. 16 illustrates an example of the smoothed individual profile LOESS (I(i, x) f(x)). The smoothed individual profile LOESS (I(i, x) f(x)) is further smoothed than the weighted individual profile I(i, x) f(x) illustrated in FIG. 14.

Referring back to FIG. 15, the processor 20 calculates peak positions of the smoothed individual profile LOESS (I(i, x) f(x)) and regards the peak positions as the edge positions e1, e2, . . . in S262. After S262, the processor 20 ends the processing of the flowchart and returns to the processing illustrated in FIG. 6.

In S27 of FIG. 6, the processor 20 determines whether or not the value of the coordinate i in the Y direction has reached n. In a case where the value of i has reached n (S27: YES), the processor 20 moves on to the processing in S28. In a case where the value of i has not reached n (S27: NO), the processor 20 returns the processing to S24.

In S28, the processor 20 generates alignment data of pattern edges from n sets of data of the edge positions e1, e2, . . . obtained by repeating S24 to S26 n times.

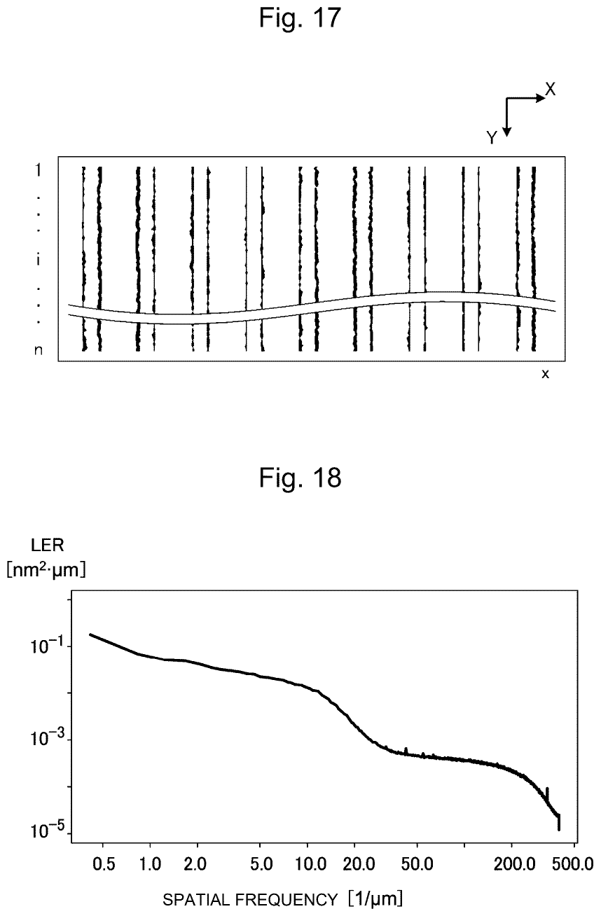

FIG. 17 illustrates alignment of the edge positions e1, e2, . . . included in the alignment data in the XY plane. After S28 of FIG. 6, the processor 20 ends the processing of the flowchart and returns to the processing illustrated in FIG. 3.

FIG. 18 illustrates an example of a result of the PSD analysis on the pattern edges. Among spatial frequency components of LER, components having spatial frequencies of equal to or less than 15/μm are often attributable to a light source device, and components having spatial frequencies of greater than 15/μm are often attributable to a resist composition. It is possible to identify causes of occurrence of LER through the PSD analysis and to use the result of the identification to improve exposure performance.

### 3.2 Effects

(1) According to the first embodiment, the edge position determination method includes first determining the average edge positions a1, a2, . . . by aggregating the intensity values in the Y direction in the SEM image of line-and-space. Next, the individual profile I(i, x) indicating distribution of the intensity values in the X direction perpendicular to the Y direction at coordinates i indicating each position in the Y direction in the SEM image is fitted using the weight function f(x) in which the weight at the average edge positions a1, a2, . . . is the largest and the fitting function defined in accordance with the individual profile I(i, x). Next, the edge positions e1, e2, . . . at the coordinates i are determined from the smoothed individual profile LOESS (I(i, x) f(x)) obtained through the fitting.

With this configuration, the weight function f(x) in which the weight at the average edge positions a1, a2, . . . is the largest is used, a loss of intensity value data at a part close to the average edge positions a1, a2, . . . is thus suppressed, and it is possible to reduce noise at a part spaced apart from the average edge positions a1, a2, . . . . In addition, since the fitting is performed using the fitting function defined in accordance with the individual profile I(i, x), influences of the intensity profiles at other coordinates i can be suppressed.

(2) According to the first embodiment, the weight function f(x) is a function that is smaller as the distance from the average edge positions a1, a2, . . . increases in the first section #1 where the distance is equal to or less than the predetermined value that is smaller than the interval d between the average edge positions and another closest average edge position.

With this configuration, the smaller the distance from the average edge positions a1, a2, . . . is, the more data loss is suppressed, and the larger the distance from the average edge positions a1, a2, . . . is, the more noise can be reduced. Therefore, parts that are true edge positions are more likely to be able to be determined as the edge positions e1, e2, . . . , and parts that are not the true edge positions are more likely to be able to be determined as not the edge positions e1, e2, . . . .

(3) According to the first embodiment, in the first section, the absolute value of the derivative of the weight function is the smallest at the average edge positions a1, a2, . . . .

With this configuration, since the reduction rate is made gentle in the vicinity of the average edge positions a1, a2, . . . , it is possible to highly evaluate parts with certain widths which are likely to be true edge positions and to reduce the probability of missing the true edge positions.

(4) According to the first embodiment, the weight function f(x) is symmetric with respect to the average edge positions a1, a2, . . . in the first section #1 where the distance from the average edge positions a1, a2, . . . is equal to or less than the predetermined position.

With this configuration, it is possible to determine the edge positions e1, e2, . . . by uniformly evaluating the intensity values at the positions equidistant from the average edge positions a1, a2, . . . .

(5) According to the first embodiment, the value of the weight function f(x) is equal to or less than half the weight at the average edge positions a1, a2, . . . in the second sections #2 and #20 where the distance from the average edge positions a1, a2, . . . is greater than the predetermined value.

With this configuration, it is possible to suppress influences of noise at parts that are significantly unlikely to be true edge positions on determination of the edge positions e1, e2, . . . by setting the weight in a case where the distance from the average edge positions a1, a2, . . . is greater than the predetermined value to equal to or less than half the peak value.

(6) According to the first embodiment, the value of the weight function f(x) is equal to or less than half the weight at the average edge positions a1, a2, . . . in the case where the distance from the average edge positions a1, a2, . . . is half the interval d.

With this configuration, it is possible to reduce the probability that parts that are not true edge positions are determined to be the edge positions e1, e2, . . . by sufficiently reducing the weight among the peaks.

(7) According to the first embodiment, the value of the weight function f(x) is a constant value regardless of the distance from the average edge positions a1, a2, . . . in the second section #2 where the distance is greater than the predetermined value.

With this configuration, it is possible to reduce a calculation load at parts that are significantly unlikely to be the true edge positions by setting the weight in the case where the distance from the average edge positions a1, a2, . . . is greater than the predetermined value to the constant value.

(8) According to the first embodiment, the value of the weight function f(x) is zero regardless of the distance from the average edge positions a1, a2, . . . in the second section #2 where the distance is greater than the predetermined value.

With this configuration, it is possible to ignore the parts that are significantly unlikely to be the true edge positions by setting the weight in the case where the distance from the average edge positions a1, a2, . . . is greater than the predetermined value to zero.

(9) According to the first embodiment, when the position in the X direction perpendicular to the Y direction is defined as x, the average edge position is defined as a, and b is defined as a constant, the weight function f(x) is (1−|(x−a)/b|³)³ in a section where |(x−a)/b| is equal to or less than one and is zero in a section where |(x−a)/b| is greater than one.

With this configuration, it is possible to set the weight function f(x) in which the weight at the average edge position a is the largest and the weight decreases in accordance with the constant b as the distance from the average edge position a increases. Also, it is possible to ignore parts that are significantly unlikely to be the true edge positions by setting the weight to zero in the section where |(x−a)/b| is greater than one.

(10) According to the first embodiment, when the position in the X direction perpendicular to the Y direction is defined as x, the average edge position is defined as a, and b is defined as a constant, the weight function f(x) is exp (−((x−a)/b)²).

With this configuration, it is possible to set, as the weight function f(x), a Gaussian function in which the weight at the average edge position a is the largest and the weight monotonically decreases in accordance with the constant b as the distance from the average edge position a increases.

(11) According to the first embodiment, when the position in the X direction perpendicular to the Y direction is defined as x, the average edge position is defined as a, and b is defined as a constant, the weight function f(x) is 1/(1+((x−a)/b)²).

With this configuration, it is possible to set, as the weight function f(x), a Lorentz function in which the weight at the average edge position a is the largest and the weight monotonically decreases in accordance with the constant b as the distance from the average edge position a increases.

(12) According to the first embodiment, the individual profile I(i, x) at first coordinates indicating a first position in the Y direction and the individual profile I(i, x) at second coordinates indicating a second position in the Y direction are fitted using the weight function f(x) that is common to both the first intensity profile at the first coordinates and the first intensity profile at the second coordinates.

With this configuration, the same weight function f(x) is used for evaluation at different coordinates i in the extension direction of the lines, and it is thus possible to reduce variations in evaluation due to the difference in coordinates i.

(13) According to the first embodiment, the smoothed individual profile LOESS (I(i, x) f(x)) is obtained by fitting, using the fitting function, the weighted individual profile I(i, x) f(x) obtained by multiplying the individual profile I(i, x) using the weight function f(x).

With this configuration, it is possible to reduce a calculation load of the fitting by multiplying the weight function f(x) before the fitting.

(14) According to the first embodiment, a method of fitting the weighted individual profile I(i, x) f(x) using the fitting function is either the LOWESS method or the LOESS method.

With this configuration, it is possible to appropriately perform the fitting without the fitting function restrained by a specific functional form.

(15) According to the first embodiment, the peak positions of the smoothed individual profile LOESS (I(i, x) f(x)) are determined as the edge positions e1, e2, . . . .

With this configuration, it is possible to appropriately determine the edge positions e1, e2, . . . .

(16) According to the first embodiment, the average edge positions a1, a2, . . . are determined by smoothing the average intensity profile ΣI(i, x)/n obtained by aggregating the intensity values included in the individual profile I(i, x) in the Y direction.

With this configuration, it is possible to appropriately determine the average edge positions a1, a2, . . . by smoothing the average intensity profile ΣI(i, x)/n.

(17) According to the first embodiment, a method of smoothing the average intensity profile ΣI(i, x)/n is either the LOWESS method or the LOESS method.

With this configuration, it is possible to appropriately smooth the average intensity profile ΣI(i, x)/n using either the LOWESS method or the LOESS method.

In regard to the other points, the first embodiment is similar to the comparative example.

### 4. Method Using Weight Function f(x) as Weight of Local Regression

4.1 Processing of Determining Pattern Edges from SEM Image

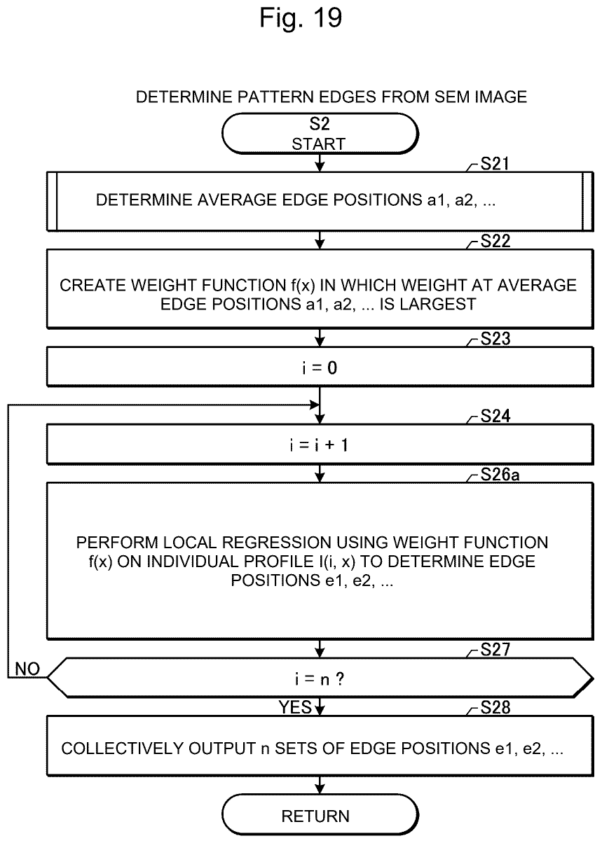

FIG. 19 is a flowchart illustrating details of processing of determining pattern edges from a SEM image in a second embodiment. A configuration of an edge position determination apparatus 100 in the second embodiment is similar to that described with reference to FIG. 1. Edge analysis processing in the second embodiment is similar to that described with reference to FIG. 3. FIG. 19 corresponds to a sub-routine of S2 in FIG. 3 and differs from the first embodiment in that processing in S26a is performed instead of S25 and S26 of FIG. 6.

In S26a, a processor 20 performs local regression on an individual profile I(i, x) using a weight function f(x) as a weight of the local regression and determines edge positions e1, e2, . . . . A smoothed individual profile obtained through the weighted local regression in S26a is an example of the second intensity profile in the present disclosure. The processing of the local regression includes processing of performing fitting using a fitting function defined in accordance with the individual profile I(i, x). Either the LOWESS method or the LOESS method can be used as the fitting method. The same weight function f(x) is used in the fitting of the individual profile I(i, x) regardless of positions in the Y direction.

### 4.2 Effects

(18) According to the second embodiment, the weight function f(x) is used as the weight when the individual profile I(i, x) is fitted using the fitting function.

With this configuration, there is no need to perform multiplication between the individual profile I(i, x) and the weight function f(x), and it is thus possible to increase the calculation speed.

In regard to the other points, the second embodiment is similar to the first embodiment.

### 5. Others

The description is intended to be illustrative and the present disclosure is not limited thereto. Therefore, it would be obvious to those skilled in the art that various modifications to the embodiments of the present disclosure would be possible without departing from the scope of claims. Further, it would be also obvious for those skilled in the art that embodiments of the present disclosure would be appropriately combined.

The terms used throughout the present specification and the scope of claims should be interpreted as non-limiting terms unless otherwise stated. For example, terms such as “include”, “have”, “comprise”, and “contain” should “not be interpreted to be exclusive of elements other than the described elements”. Further, indefinite articles “a/an” described should be interpreted to mean “at least one” or “one or more”. Further, “at least one of A, B, and C” should be interpreted to mean any of “A”, “B”, “C”, “A+B”, “A+C”, “B+C”, and “A+B+C” as well as to include combinations of any thereof and any other than “A”, “B”, and “C”.

What is claimed is:

1. An edge position determination method comprising:
determining an average edge position by aggregating intensity values in an extension direction of lines in a SEM image of line-and-space;
fitting a first intensity profile indicating distribution of the intensity values in a direction perpendicular to the extension direction at coordinates indicating each position in the extension direction in the SEM image using a weight function in which a weight at the average edge position is the largest and a fitting function defined in accordance with the first intensity profile; and
determining an edge position at the coordinates from a second intensity profile obtained through the fitting.

2. The edge position determination method according to claim 1, wherein
the weight function is a function that is smaller as a distance from the average edge position increases in a first section where the distance is equal to or less than a predetermined value that is smaller than an interval between the average edge position and another closest average edge position.

3. The edge position determination method according to claim 2, wherein
in the first section, an absolute value of a derivative of the weight function is the smallest at the average edge position.

4. The edge position determination method according to claim 2, wherein
the weight function is symmetric with respect to the average edge position in the first section.

5. The edge position determination method according to claim 2, wherein
a value of the weight function is equal to or less than half the weight at the average edge position in a second section where the distance is greater than the predetermined value.

6. The edge position determination method according to claim 2, wherein
a value of the weight function is equal to or less than half the weight at the average edge position in a case where the distance is half the interval.

7. The edge position determination method according to claim 2, wherein
a value of the weight function is a constant value regardless of the distance in a second section where the distance is greater than the predetermined value.

8. The edge position determination method according to claim 2, wherein
a value of the weight function is zero regardless of the distance in a second section where the distance is greater than the predetermined value.

9. The edge position determination method according to claim 1, wherein
when a position in a direction perpendicular to the extension direction is defined as x, the average edge position is defined as a, and b is defined as a constant, the weight function is (1−|(x−a)/b|³)³ in a section where |(x−a)/b| is equal to or less than one and is zero in a section where |(x−a)/b| is greater than one.

10. The edge position determination method according to claim 1, wherein
when a position in a direction perpendicular to the extension direction is defined as x, the average edge position is defined as a, and b is defined as a constant, the weight function is exp (−((x−a)/b)²).

11. The edge position determination method according to claim 1, wherein
when a position in a direction perpendicular to the extension direction is defined as x, the average edge position is defined as a, and b is defined as a constant, the weight function is 1/(1+((x−a)/b)²).

12. The edge position determination method according to claim 1, wherein
the first intensity profile at first coordinates indicating a first position in the extension direction and the first intensity profile at second coordinates indicating a second position in the extension direction are fitted using the weight function that is common to both the first intensity profile at the first coordinates and the first intensity profile at the second coordinates.

13. The edge position determination method according to claim 1, wherein
the second intensity profile is obtained by fitting, using the fitting function, a third intensity profile obtained by multiplying the first intensity profile using the weight function.

14. The edge position determination method according to claim 1, wherein
a method of performing the fitting using the fitting function is either a LOWESS method or a LOESS method.

15. The edge position determination method according to claim 1, wherein
a peak position of the second intensity profile is determined as the edge position.

16. The edge position determination method according to claim 1, wherein
the average edge position is determined by smoothing a fourth intensity profile obtained by aggregating the intensity values included in the first intensity profile in the extension direction.

17. The edge position determination method according to claim 16, wherein
a method of smoothing the fourth intensity profile is either a LOWESS method or a LOESS method.

18. The edge position determination method according to claim 1, wherein
the weight function is used as a weight when the first intensity profile is fitted using the fitting function.

19. An edge position determination apparatus comprising:
a communication controller configured to acquire a SEM image of line-and-space; and
a processor configured to
determine an average edge position by aggregating intensity values in an extension direction of lines in the SEM image,
fit a first intensity profile in a direction perpendicular to the extension direction at coordinates indicating each position in the extension direction in the SEM image using a weight function in which a weight at the average edge position is the largest and a fitting function defined in accordance with the first intensity profile, and
determine an edge position at the coordinates from a second intensity profile obtained through the fitting.

20. An edge analysis method comprising:
determining an average edge position by aggregating intensity values in an extension direction of lines in a SEM image of line-and-space;
fitting a first intensity profile in a direction perpendicular to the extension direction at coordinates indicating each position in the extension direction in the SEM image using a weight function in which a weight at the average edge position is the largest and a fitting function defined in accordance with the first intensity profile;
determining an edge position at the coordinates from a second intensity profile obtained through the fitting; and
performing PSD analysis on the edge position at each of a plurality of positions in the extension direction.
